(19) United States
(12) Patent Application Publication
(10) Pub. No.: US 2014/0295893 A1
(43) Pub. Date: Oct. 2, 2014

(54) Method, Apparatus and System for Enabling the Recall of Content of Interest for Subsequent Review

(71) Applicant: THOMSON LICENSING, Issy de Moulineaux (FR)

(72) Inventor: Gregory Charles Herlein, San Francisco, CA (US)

(73) Assignee: THOMSON LICENSING, Issy de Moulineaux (FR)

(21) Appl. No.: 14/353,700

(22) PCT Filed: Nov. 30, 2012
(86) PCT No.: PCT/US12/67238

§ 371 Date: Apr. 23, 2014

Related U.S. Application Data
(60) Provisional application No. 61/565,134, filed on Nov. 30, 2011.

(51) Int. Cl. H04W 4/02

(52) U.S. Cl. CPC H04W 4/02
USPC 455/456.3

(57) ABSTRACT

A method, apparatus and system for enabling the recall of content for subsequent review include receiving an indication of interest in content displayed in proximity to a mobile communications device, identifying the mobile communications device using information in the received interest indication, and using determined communication information related to the identification of the mobile communications device to communicate, for storage in the mobile communications device, at least one of the content of interest, content data of the content of interest and location information of the content of interest.

### CROSS-REFERENCE TO RELATED APPLICATIONS

This application claims the benefit of the filing date of the following U.S. Provisional Application, which is hereby incorporated by reference in its entirety for all purposes: Ser. No. 61/565,134, filed on Nov. 30, 2011.

### FIELD OF THE INVENTION

The present invention generally relates to the presentation of content, such as advertising content and, more particularly, to a method, apparatus and system for enabling the recall of content for subsequent review.

### BACKGROUND OF THE INVENTION

Consumers are often exposed to product information on video screens during times when such consumers have little time to absorb the information being presented. For example, in a retail advertising environment, there may be a video ad playing on a screen in a store for a new product. The shopper is potentially interested in learning more about that product but they are in a hurry. The problem is that the product message is fleeting. Without some means to store the information in the ad in a manner that can be easily recalled by the consumer, the consumer is left only with a vague memory about the product they saw in the advertisement. In fact, even in circumstances in which a means is available to store the product information into a queue for later review, a consumer may still lack the ability to recall a particular advertisement from all stored advertisements.

Currently there exists a product called ‘Instapaper’ that provides a means for a mobile internet or internet user to see an article of interest and mark it for later reading when it is more convenient or on a reading device more suitable for careful reading. However, that only works on screens for on which a user controls the media consumption (e.g., a PC or mobile communications device). In such an application, there is no way to tag things you see on a screen so that you can review that material later.

### SUMMARY OF THE INVENTION

Embodiments of the present invention address the deficiencies of the prior art by providing a method, apparatus and system for enabling the recall of content of interest for subsequent review.

In one embodiment of the present invention, a method includes receiving an indication of interest in content displayed in proximity to a mobile communications device, identifying the mobile communications device using information in the received interest indication and using the determined identity of the mobile communications device to communicate for storage in the mobile communications device at least one of the content of interest, content data of the content of interest and location information of the content of interest.

In an alternate embodiment of the present invention, an apparatus includes a memory for storing program routines and data and a processor for executing the program routines such that the apparatus configured to receive an indication of interest in content displayed in proximity to a mobile communications device, identify the mobile communications device using information in the received interest indication and use the determined identification of the mobile communications device to communicate for storage in the mobile communications device at least one of the content of interest, content data of the content of interest and location information of the content of interest.

In an alternate embodiment of the present invention a system for enabling the recall of content for subsequent review includes at least one content source for providing media content, an apparatus including a memory for storing program routines and data, and a processor for executing the program routines and a display for displaying at least the content of interest. In the system of the present invention the apparatus is configured to receive an indication of interest in content displayed in proximity to a mobile communications device, identify the mobile communications device using information in the received interest indication and to use the determined identification of the mobile communications device to

communicate for storage in the mobile communications device at least one of the content of interest, content data of the content of interest and location information of the content of interest.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising in which an embodiment of the present invention can be applied;

FIG. 3 depicts a high level block diagram of a server capable of performing the various described inventive aspects of the invention described herein in accordance with an embodiment of the present invention; and

FIG. 4 depicts a flow diagram of a method for storing content of interest for easy recall and subsequent review by a consumer in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for storing at least one of content of interest, content data for the content of interest and location information for the content of interest for content exposed to a mobile communications device for enabling subsequent review of the stored information. Although the present invention will be described primarily within the context of a retail advertising environment, the specific embodiments of the present invention should not be treated as limiting the scope of the invention. It will be appreciated by those skilled in the art and informed by the teachings of the present invention that the concepts of the present invention can be implemented in any content distribution or communications network utilizing screens or displays to display media content, such as video-on-demand systems and the like. In addition, although the present invention will be described primarily within the context of a advertising content such as commercials for products, it will be appreciated by those skilled in the art and informed by the teachings of the present invention that in various embodiments of the present invention, the content described in conjunction with the various embodiments of the present invention can include service advertisements, media content such as on-demand content, coupons, personalized offers and the like. In addition, although the present invention will be described primarily within the context of storing content in a mobile communications device, it will be appreciated by those skilled in the art and informed by the teachings of the present invention that in various embodiments of the present invention, the concepts of the present invention can be applied to the storage of content data, location information for the content and the like, in any communication device for display on any screen device.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

Embodiments of the present invention provide methods and means for the storage on, for example, a mobile communications device of at least content of interest, content data for the content of interest and location information of the content of interest, for example advertising content, for enabling subsequent review or display of the stored information. That is, in various embodiments of the present invention, a user/shopper is provided with a method and means to easily tag an offering for later review/display through the use of a mobile communications device such as a cell phone or a tablet computer. It should be noted that in various embodiments of the present invention, content data of content of interest as described herein can include information regarding the products and services or other objects depicted in the content of interest. It should further be noted that in various embodiments of the present invention, location information of content as described herein can include address information of where content is stored such as address information of a content server or internet locations from which the content can be accessed/retrieved.

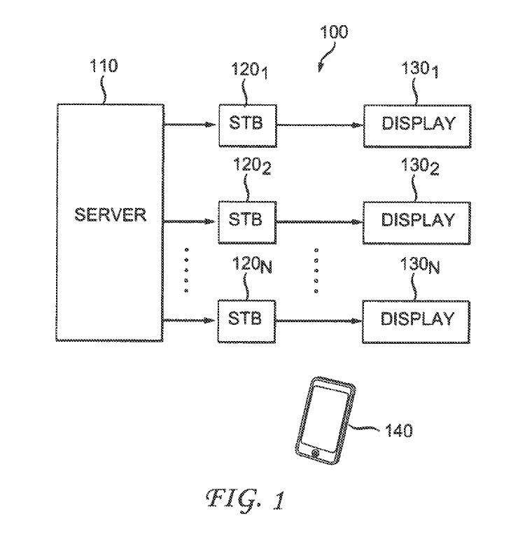

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ. FIG. 1 further depicts a mobile communications device 140 (illustratively a mobile phone) which can be carried throughout the content distribution system 100 by a user (e.g., customer or service technician) and can be used in accordance with the concepts of the present invention for determining content of interest to a user and to what content the mobile communications device and, as such the user, are exposed.

Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

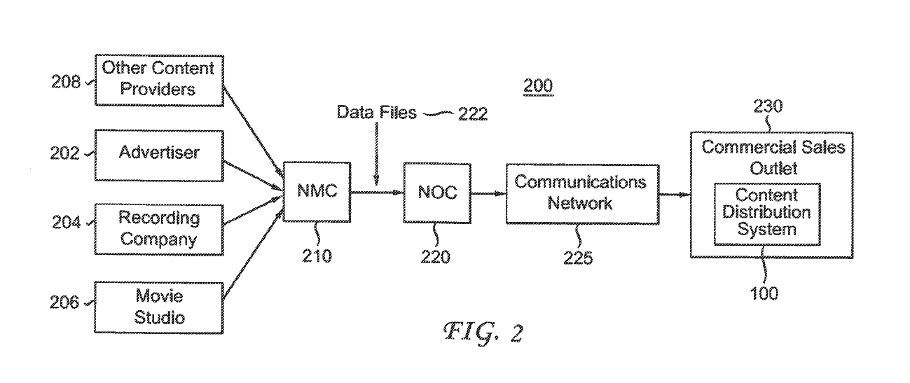

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

As described above, the various embodiments of the present invention provide methods and means for a mobile communications device user to ‘save’ at least location information of an advertisement or other media content on a mobile communications device for later review. As also described above, in one embodiment of the present invention a QR code scanned by a user is communicated to a URL of a server. In various embodiments of the present invention, such server can include the server 110 of the content distribution system 100 or the NMC 210 or NOC 220 of the in-store advertising network 200. The server running that page identifies the user (i.e., through a cookie or javascript) and then acts on the users behalf to store the product URL in, for example in one embodiment, the personal information cache of the mobile communications device.

In one embodiment of the present invention, a respective quick response (QR) code is displayed on an advertising screen concurrent with advertising content. A user, if interested in the content can then scan the QR code using a mobile communications device. In such an embodiment, a user's mobile communications device must include scanning software to read the QR code. The QR code scanned by the user is communicated to a uniform resource locator (URL) of a server (i.e., a server of a content distribution system or server of an advertising network depicted in FIG. 1 and FIG. 2, below). The server running the page identifies the user/mobile communications device (i.e., through a cookie or javascript) and information to be used to communicate with the mobile communications device by, in one embodiment displaying a page on the mobile communications device browser. In one embodiment of the present invention, the server then communicates to the mobile communications device at least one of the content of interest, content data of the content of interest or location information of the content of interest for storage on the mobile communications device. That is, in one embodiment, a server of the present invention communicates content for which the user has indicated interest, such as advertising content, to the mobile communications device of the user for storage. In an alternate embodiment of the present invention, a server of the present invention communicates content data, such as product information for products presented in the content and the like, to the mobile communications device for storage. In yet an alternate embodiment of the present invention, a server of the present invention acts on behalf of the user and saves a URL of the content of interest in, for example, a personal information cache of the user's mobile communication device. The user of the mobile communications device is then able to, at a later time, recall the information stored in the mobile communications device to review the stored content of interest, to review the content data (e.g., product information) of the content of interest, and/or to locate the content of interest in an alternate location, such as on an internet site. In accordance with various embodiments of the present invention, the information stored on the mobile communications device can be reviewed on an audio device or a video device (e.g., a screen) of the mobile communications device and/or can be communicated to an alternate audio device or video device, whether in the content distribution environment or an alternate personal audio device or video device in an alternate location for subsequent review.

In an alternate embodiment of the present invention, an advertising screen includes a near field communication (NFC) pad. In such an embodiment, a user taps an NFC-enabled mobile communications device to the NFC pad to indicate interest in a particular advertising content/product. The NFC capability and functionality of a user's mobile communications device is used by a server in communication with the NFC pad to identify the mobile communications device and information to be used to communicate with the mobile communications device. The server then, using the determined communication information of the mobile communications device, communicates, for storage in the mobile communications device, at least one of the content of interest, content data of the content of interest and location information of the content of interest. For example, in one embodiment of the present invention, the server causes the storage of a product URL of the content in, for example in one embodiment, a cache of the mobile communications device. In an alternate embodiment of the present invention, the server communicates content of interest to the mobile communications device for storage in the mobile communications device.

In yet an alternate embodiment of the present invention, a user's mobile communications device is tracked as it moves throughout a retail advertising environment and as it moves in and out of the proximity of advertising screens (i.e., using address detection or other known mobile device detection means such as ESN detection). That is, in one embodiment of the present invention, a user can chose to provide the media access control (MAC) address of their mobile communications device within an advertising environment such that communication can be established with the mobile communications device and such that the user's mobile communications device can be tracked as it moves throughout a store and as it moves in and out of the proximity of advertising screens such that it can be tracked to which content the user and the user's mobile communications device were exposed while in an advertising environment.

Even further, using information known by the server (e.g., the server 110, the NMC 210 or the NOC 220) such as playlist information, the location of advertising screens in the store, and the location of the user, the server can keep track of all of the advertising content presented to the user and exposed to the user's mobile communications device and at which location a specific piece of advertising content was presented to the user and the user's mobile communications device.

In an embodiment of the present invention, such information is supplemented using information collected on the user's mobile communications device to assist in identifying what content was presented to a user. For example, in one embodiment of the present invention, a user is encouraged to have an appropriate application executing on the user's mobile communications device that records the audio ‘heard’ by the microphone of the mobile communications device and acoustically match the recorded audio to known advertisements expected to be playing in the area in which the user was known to have been.

In an alternate embodiment of the present invention, a user is encouraged to use the camera or video camera capabilities of the user's mobile communications device to photograph an advertising screen in the proximity of the user to identify the advertising content being presented in the proximity of the user.

In an alternate embodiment of the present invention, network ‘beacons’ are used to identify to a user's mobile communications device what advertising content is playing and on which screen location. The mobile communications device informs the server of the present invention of what it has confirmed to have been exposed to using the beacons.

In various embodiments of the present invention such as those described herein, information collected by a server of the present invention is used to make a list of what advertising content/products to which the user's mobile communications device and the user have been exposed. Such a list is communicated to the user's mobile communications device to enable the user to refer to the list of advertising content/products to which the user was exposed such that a user can quickly select which content to store or for which advertising content/product to store information, such as the product URL in, for example in one embodiment, the personal information cache of the mobile communications device.

An example will now be described to assist in the understanding of the above described embodiments of the present invention. For example, a consumer walks through a retail store to purchase a product, for example milk. On the way to the back of the store to pick up the milk, the consumer and the consumer's mobile communications device are exposed to advertising content being displayed on a screen; the advertising content directed to the description of a new video game. The consumer gets the milk and while standing in the check-out line refers to a list of content to which the consumer and the consumer's mobile communications device were exposed, the list being made available to the consumer's mobile communications device as described above.

In one embodiment of the present invention, the list is presented to the consumer on the consumer's mobile communications device in the form of a drop down menu. Using the drop down menu, the consumer is able to see a list of the advertising content/products to which the consumer and the consumer's mobile communications device were exposed during the consumer's time in the store. In one embodiment, the list of advertising content/products can be arranged in the order in which the consumer was exposed to the content. Using the list, the consumer is able to see the advertising content for the video game that the consumer saw being advertised on the screen.

In one embodiment of the present invention, the consumer can then elect to save information regarding that product or the advertising content for that product by taping on the screen of his mobile communications device to save such information to a personal queue of the mobile communications device to be able to review the saved data at a later time.

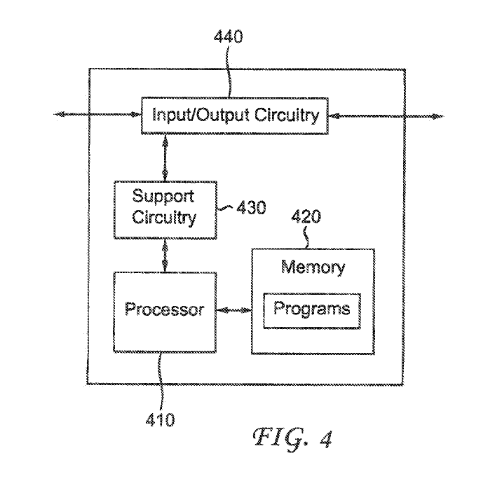

FIG. 4 depicts a high-level block diagram of a server 110, 210, 220 capable of performing the various described aspects of the invention described herein in accordance with an embodiment of the present invention. More specifically, the server of FIG. 4 illustratively comprises a processor 410 as well as a memory 420 for storing control programs, file information, stored media and the like. The processor 410 cooperates with conventional support circuitry 430 such as power supplies, clock circuits, cache memory and the like as well as circuits that assist in executing the software routines stored in the memory 420. As such, it is contemplated that some of the process steps discussed herein as software processes may be implemented within hardware, for example, as circuitry that cooperates with the processor 410 to perform various steps. The server of FIG. 4 also contains input-output circuitry 440 that forms an interface between various functional elements communicating with the server of FIG. 4.

Again, although the server of FIG. 4 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software executed by a processor, hardware, or a combination thereof. In addition, server of FIG. 4 is depicted as a separate component, the functionalities of the server in accordance with the concepts and embodiments of the present invention described herein can be incorporated into an existing content management system component such as a set-top box, personal video recorder, digital video recorder or content provider server and the like.

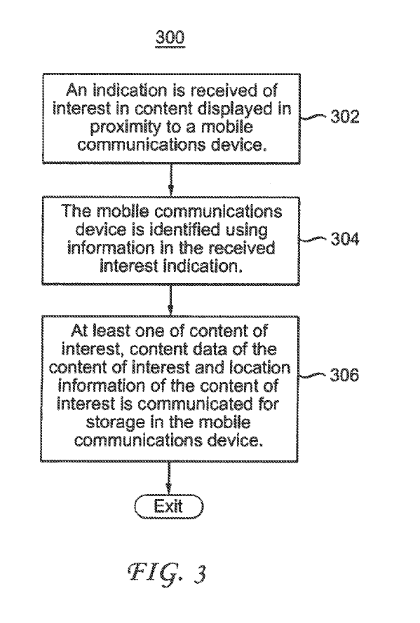

FIG. 3 depicts a flow diagram of a method for enabling the recall of content of interest for subsequent review in accordance with an embodiment of the present invention. The method 300 begins at step 302 during which an indication is received, for example by a server, that a user/consumer is interested in specific content being presented, such as advertising content for a product. For example, in one embodiment of the present invention, a user, if interested in content, can then scan, using the user's mobile communication device, a QR code, which is displayed on a display screen concurrent with content. The QR code scanned by the user is communicated to a server, such as a content server, to indicate a user's interest in the content being presented. In an alternate embodiment of the present invention, an advertising screen includes a near field communication (NFC) pad and a user taps their NFC-enabled mobile communications device to the NFC pad to indicate interest, to, for example a content server, in content being presented. In yet an alternate embodiment of the present invention, a user provides a means of tracking the user's mobile communications device within an advertising environment as an indication of interest to a server of the present invention in keeping track of content to which the consumer and the consumer's mobile communications device are exposed during their time in, for example an advertising environment. The method 300 then proceeds to step 304.

At step 304, a user/user mobile communications device indicating interest in the presented content is identified using the method described above for communicating an indication of interest in the content to a server of the present invention. For example, in one embodiment of the present invention, a server identifies the user's mobile communications device through a cookie or javascript. Once a mobile communications device is identified, communication parameters for that mobile communications device can be determined using the method for identifying the mobile communications device. In alternate embodiments of the present invention, once a mobile communications device is identified, communication information for that mobile communications device can be determined from previously stored information for a mobile communications device, such as information related to customer loyalty information or information previously determined for a mobile communications device.

In an alternate embodiment of the present invention, a user/user device is identified via the NFC hardware and functionality of a user's mobile communications device. In yet an alternate embodiment of the present invention, a user's mobile communications device is identified via a MAC address of the mobile communications device as described above. The method 300 then proceeds to step 306.

At step 306, the communication information for the mobile communications device determined in step 304 is used to communicate, for storage in the mobile communications device, at least one of the identified content of interest, content data of the content of interest and location information of the content of interest. For example, in one embodiment of the present invention content for which the user has indicated interest, such as advertising content, is communicated to the mobile communications device for storage in the mobile communications device. In an alternate embodiment of the present invention, content data, such as product information for products presented in the content and the like, is communicated to the mobile communications device for storage in the mobile communications device. In yet an alternate embodiment of the present invention, a server of the present invention saves a URL of the content of interest in, for example, a personal information cache of the user's mobile communication device.

In an alternate embodiment of the present invention, a list of what advertising content/products to which the user's mobile communications device and the user have been exposed is communicated to the mobile communications device for storage in the mobile communications device such that a user can refer to the list of advertising content/products to which the user and mobile communications device were exposed such that a user is able select for which advertising content/product to request information, such that a server of the present invention can communicate at least one of the identified content of interest, content data of the content of interest and location information of the content of interest for storage in a memory of the mobile communications device. The method 300 can then be exited.

Having described various embodiments for a method, apparatus and system for enabling the recall of content of interest for subsequent review on a mobile communications device (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method, comprising:
receiving an indication of interest in content displayed in proximity to a mobile communications device;
identifying the mobile communications device using information in the received interest indication; and
using said identification of the mobile communications device to communicate for storage in the mobile communications device at least one of said content of interest, content data of said content of interest and location information of said content of interest.

2. The method of claim 1, wherein a quick response code included with said content is scanned using the mobile communications device to indicate interest in said content.

3. The method of claim 2, wherein the quick response code scanned by the mobile communications device is communicated to a source of said content.

4. The method of claim 2, comprising identifying the mobile communications device using a least one of a cookie and javascript.

5. The method of claim 1, comprising storing a uniform resource locator of said content of interest in a cache of the mobile communications device.

6. The method of claim 1, wherein near field communication is used by the mobile communications device to indicate interest in said content.

7. The method of claim 6, comprising identifying the mobile communications device using near field communication capability and functionality of the mobile communications device.

8. The method of claim 1, wherein a user of the mobile communications device provides a media access control address of the mobile communications device to a source of content to indicate interest in content presented in proximity to the mobile communications device.

9. The method of claim 8, comprising tracking a location of the mobile communications device using the provided media access control address to determine content to which the mobile communications device was exposed.

10. The method of claim 1, comprising using functionalities of the mobile communications device to identify content of interest presented in proximity of the mobile communications device.

11. The method of claim 1, comprising using at least one of said stored content of interest and said stored location information of said content of interest to view said content of interest at a time later than the intended presentation time of said content.

12. The method of claim 1, comprising playing said content of interest on the mobile communications device at a time later than the original presentation time of said content using at least one of said stored content of interest and said stored location information of said content of interest.

13. The method of claim 1, comprising communicating information regarding to what content the mobile communications device was exposed in the form of a list.

14. The method of claim 13, wherein the list is presented on the mobile communications device as a drop-down menu.

15. The method of claim 14, wherein said drop-down menu is used to select at least one of which content to store in said mobile communications device and for which content to store location information in said mobile communications device.

16. The method of claim 1, wherein network beacons are used to identify to the mobile communications device what content is playing on a respective display and the location of the respective display.

17. The method of claim 16, wherein the mobile communications device indicates to what content it has been exposed using the network beacons.

18. An apparatus, comprising:
a memory for storing program routines and data; and
a processor for executing said program routines;
said apparatus configured to:
receive an indication of interest in content displayed in proximity to a mobile communications device;
identify the mobile communications device using information in the received interest indication; and
use said identification of the mobile communications device to communicate for storage in the mobile communications device at least one of said content of interest, content data of said content of interest and location information of said content of interest.

19. The apparatus of claim 18, wherein said apparatus comprises a content server.

20. A system for enabling the recall of content for subsequent review, comprising:
at least one content source for providing media content;
an apparatus including a memory for storing program routines and data, and a processor for executing said program routines, said processor, when executing said program routines, configured to:
receive an indication of interest in content displayed in proximity to a mobile communications device;
identify the mobile communications device using information in the received interest indication; and
use said identification of the mobile communications device to communicate for storage in the mobile communications device at least one of said content of interest, content data of said content of interest and location information of said content of interest; and
a display for displaying at least the content of interest.
